(19) United States
(12) Patent Application Publication
(10) Pub. No.: US 2026/0003878 A1
(43) Pub. Date: Jan. 1, 2026

(54) APPARATUS AND METHOD FOR LEARNING MIXED DATA FOR APPROXIMATE QUERIES

(71) Applicant: ELECTRONICS AND TELECOMMUNICATIONS RESEARCH INSTITUTE, Daejeon (KR)

(72) Inventors: Ki-Hyuk NAM, Daejeon (KR); Tae-Whi LEE, Daejeon (KR); Sung-Soo KIM, Daejeon (KR); Choon-Seo PARK, Daejeon (KR)

(21) Appl. No.: 19/089,252

(22) Filed: Mar. 25, 2025

(30) Foreign Application Priority Data
Jun. 28, 2024 (KR) 10-2024-0084963

(51) Int. Cl. G06F 16/2458; G06F 16/29; G06N 20/00

(52) U.S. Cl. CPC G06F 16/2462; G06F 16/29; G06N 20/00

(57) ABSTRACT

Disclosed herein is an apparatus and method for learning mixed data for approximate queries. The apparatus receives mixed data including relational data about information for identifying an object and spatiotemporal data about the trajectory of the object moving in a target space, discretizes the relational data and the spatiotemporal data based on a level of detail that is preset for each designated area of the target space corresponding to the trajectory of the object, and generates a mixed learning model that learns the relational data and the spatiotemporal data for each level of detail using multiple relational models and spatiotemporal models.

### CROSS REFERENCE TO RELATED APPLICATION

This application claims the benefit of Korean Patent Application No. 10-2024-0084963, filed Jun. 28, 2024, which is hereby incorporated by reference in its entirety into this application.

### BACKGROUND OF THE INVENTION

### 1. Technical Field

The present disclosure relates generally to bigdata and artificial intelligence (AI) technology, and more particularly to mixed data learning technology for approximate queries.

### 2. Description of Related Art

The size of data collected from various sensors is becoming too large to be accommodated in a single place, and the growing rate is also accelerating. In order to efficiently analyze data, approximate query techniques have emerged. The recent application of machine learning techniques enables analysis of overall characteristics of data, without the original data, using only a model trained with the data. Among various techniques, a tractable probabilistic circuit model has the advantage of being able to perform probabilistic inference on various queries. However, approximate query techniques based on machine learning, which are applied to relational data, have limitations in being applied to data with time and space concepts (e.g., vehicle travel paths, etc.).

Meanwhile, U.S. Pat. No. 9,946,933, titled “System and method for video classification using a hybrid unsupervised and supervised multi-layer architecture”, discloses a method for video classification for videos, which are one of spatiotemporal data, using an architecture in which supervised learning and unsupervised learning are mixed.

### SUMMARY OF THE INVENTION

An object of the present disclosure is to improve the efficiency of queries on a vast amount of large-scale mixed data by using approximate query techniques based on machine learning.

Another object of the present disclosure is to provide the structure and procedure of a machine-learning-based model for efficiently performing exploratory analysis on large-scale mixed data.

A further object of the present disclosure is to provide a method for training a model and performing inference by transforming original data and queries to improve the efficiency of learning and inference.

Yet another object of the present disclosure is to apply to traffic/navigation data analysis, autonomous vehicle route analysis, car-sharing service analysis, bio/medical data analysis, economic and market trend analysis, and the like.

In order to accomplish the above objects, an apparatus for learning mixed data for approximate queries according to an embodiment of the present disclosure includes one or more processors and memory for storing at least one program executed by the one or more processors, and the at least one program receives mixed data including relational data about information for identifying an object and spatiotemporal data about a trajectory of the object moving in a target space, discretizes the relational data and the spatiotemporal data based on a level of detail that is preset for each designated area of the target space corresponding to the trajectory of the object, and generates a mixed learning model that learns the relational data and the spatiotemporal data for each level of detail using multiple relational models and spatiotemporal models.

Here, the at least one program may perform transformation into three-dimensional (3D) spatial data about time, a space, and a trajectory of the spatiotemporal data.

Here, the spatiotemporal model may be configured with a three-layer structure for learning the 3D spatial data for each layer.

Here, the at least one program sets levels of detail for each designated area based on time during which the object is present in the designated area.

Here, the at least one program may discretize the relational data and the spatiotemporal data based on a probability expression for checking the trajectory of the object moving in the designated area of the target space.

Here, the at least one program may learn spatiotemporal data corresponding to the relational data by calling a spatiotemporal model and may learn the relational model by reflecting a result of learning by the spatiotemporal model to a random variable node representing a spatiotemporal column in the relational model.

Here, the at least one program may learn the relational model only when there is a change in a correlation between variables by checking the correlation each time new data is input in a process of learning the relational model.

Here, the mixed learning model may infer a trajectory of an object moving in the target space by receiving a query statement.

Here, for the relational model and the spatiotemporal model, a preset probabilistic circuits model may be used.

Here, the query statement may be transformed into a probability expression for application to the probabilistic circuits model.

Also, in order to accomplish the above objects, a method for learning mixed data for approximate queries, performed by an apparatus for learning mixed data for approximate queries, according to an embodiment of the present disclosure includes receiving mixed data including relational data about information for identifying an object and spatiotemporal data about a trajectory of the object moving in a target space, discretizing the relational data and the spatiotemporal data based on a level of detail that is preset for each designated area of the target space corresponding to the trajectory of the object, and generating a mixed learning model that learns the relational data and the spatiotemporal data for each level of detail using multiple relational models and spatiotemporal models.

Here, discretizing the relational data and the spatiotemporal data may comprise performing transformation into three-dimensional (3D) spatial data about time, a space, and a trajectory of the spatiotemporal data.

Here, the spatiotemporal model may be configured with a three-layer structure for learning the 3D spatial data for each layer.

Here, discretizing the relational data and the spatiotemporal data may comprise setting levels of detail for each designated area based on time during which the object is present in the designated area.

Here, discretizing the relational data and the spatiotemporal data may comprise discretizing the relational data and the spatiotemporal data based on a probability expression for checking the trajectory of the object moving in the designated area of the target space.

Here, generating the mixed learning model may comprise learning spatiotemporal data corresponding to the relational data by calling a spatiotemporal model; and learning the relational model by reflecting a result of learning by the spatiotemporal model to a random variable node representing a spatiotemporal column in the relational model.

Here, generating the mixed learning model may comprise learning the relational model only when there is a change in a correlation between variables by checking the correlation each time new data is input in a process of learning the relational model.

Here, the mixed learning model may infer a trajectory of an object moving in the target space by receiving a query statement.

Here, for the relational model and the spatiotemporal model, a preset probabilistic circuits model may be used.

Here, the query statement may be transformed into a probability expression for application to the probabilistic circuits model.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating an apparatus for learning mixed data for approximate queries according to an embodiment of the present disclosure;

FIG. 2 is a view illustrating a query statement for a specific situation according to an embodiment of the present disclosure;

FIG. 3 is a view illustrating a process in which mixed data is input into a relational model and a spatiotemporal model according to an embodiment of the present disclosure;

FIG. 4 is a view illustrating a process for processing conditions for spatiotemporal data in a query statement according to an embodiment of the present disclosure;

FIG. 5 is a view illustrating a process for discretizing a given target space depending on a level of detail defined by a user according to an embodiment of the present disclosure;

FIG. 6 is a view illustrating a process of encoding given data and inputting the same into two models according to an embodiment of the present disclosure;

FIG. 7 is a view illustrating a process of simultaneously learning two types of models according to an embodiment of the present disclosure;

FIG. 8 is a flowchart illustrating a method for learning mixed data for approximate queries according to an embodiment of the present disclosure;

FIG. 9 is a flowchart illustrating an inference method for mixed data for approximate queries according to an embodiment of the present disclosure; and

FIG. 10 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

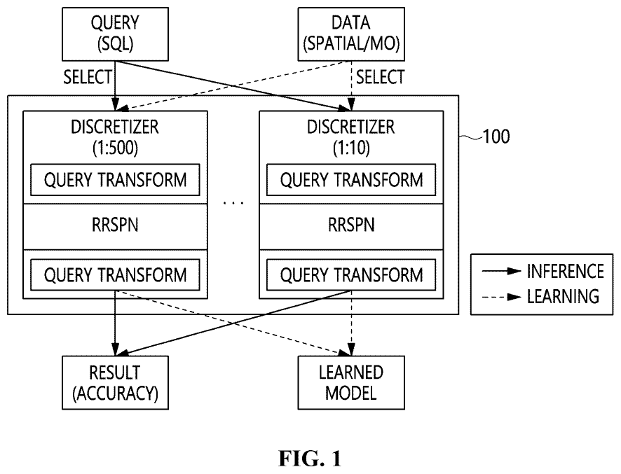

FIG. 1 is a block diagram illustrating an apparatus for learning mixed data for approximate queries according to an embodiment of the present disclosure.

Referring to FIG. 1, the apparatus 100 for learning mixed data for approximate queries according to an embodiment of the present disclosure may perform a learning procedure and an inference procedure.

The apparatus 100 for learning mixed data for approximate queries according to an embodiment of the present disclosure may include a discretizer, a probabilistic inference model, and a query transformer.

First, the apparatus 100 for learning mixed data for approximate queries according to an embodiment of the present disclosure may perform the learning procedure.

The apparatus 100 for learning mixed data may include multiple learning models, each of which is combined with a discretizer according to a Level of Detail (LoD).

In the learning procedure, the discretizer may discretize and encode the received mixed data.

Here, the mixed data may include relational data about information for identifying an object and spatiotemporal data about the trajectory of the object moving in a target space.

The apparatus 100 for learning mixed data may discretize the relational data and the spatiotemporal data based on the level of detail that is preset for each designated area of the target space corresponding to the trajectory of the object.

Here, the apparatus 100 for learning mixed data may perform transformation into 3D spatial data about time, a space, and a trajectory of the spatiotemporal data.

Here, a spatiotemporal model may be configured with a three-layer structure for learning the 3D spatial data for each layer.

In a query procedure, the discretizer may discretize and encode a received query.

Here, the query may be represented as a query statement in Structured Query Language (SQL) or the like.

Here, the discretizer may input a result of transformation of the query statement, performed by the query transformer, into the probabilistic inference model.

The probabilistic inference model may perform probabilistic inference for various queries on mixed data in which spatiotemporal data and relational data are mixed.

Here, the probabilistic inference model may correspond to a mixed learning model that includes a relational model for learning relational data and a spatiotemporal model for learning spatiotemporal data (Relational and Recurrent Sum-Product Network (RRSPN)).

Here, the spatiotemporal model may be configured with a three-layer structure for learning the 3D spatial data for each layer.

Here, for the probabilistic inference model, a tractable probabilistic circuits (PCs) model may be used.

A probabilistic circuit is one of tractable probabilistic models, and a probabilistic circuit (PC) configured to satisfy a specific condition (decomposability, smoothness) may always guarantee P-time complexity (time complexity that is mostly linear in the size of the probabilistic circuit).

Here, the probabilistic inference model may be generated individually for each Level of Detail (LoD) given in the discretization process.

Here, the apparatus 100 for learning mixed data may learn spatiotemporal data corresponding to the relational data by calling the spatiotemporal model and may learn the relational model by reflecting a result learning by the spatiotemporal model to a random variable node representing a spatiotemporal column in the relational model.

Here, the apparatus 100 for learning mixed data may learn the relational model only when there is a change in a correlation between variables by checking the correlation each time new data is input in the process of learning the relational model.

Also, the apparatus 100 for learning mixed data for approximate queries according to an embodiment of the present disclosure may perform the inference procedure.

The apparatus 100 for learning mixed data may receive a query represented as a query statement in Structured Query Language (SQL), or the like.

Here, the query statement may correspond to requesting inference of the trajectory of movement of an object that passes through a preset target area according to a specific condition in the target space.

Here, the apparatus 100 for learning mixed data may transform the query statement into a probability expression for application to the probabilistic circuits model. Here, the apparatus 100 for learning mixed data may select a LoD.

Here, the apparatus 100 for learning mixed data may infer the trajectory of an object moving in the target space from the query statement using the probabilistic inference model.

Here, the apparatus 100 for learning mixed data may transform the result obtained through the probabilistic inference model and output the final result.

The final result may provide an approximation value for the query along with the accuracy that reflects an error occurring in the discretization step and an error occurring in the machine-learning process.

The apparatus 100 for learning mixed data for approximate queries may select the algorithm to be applied to model learning in advance.

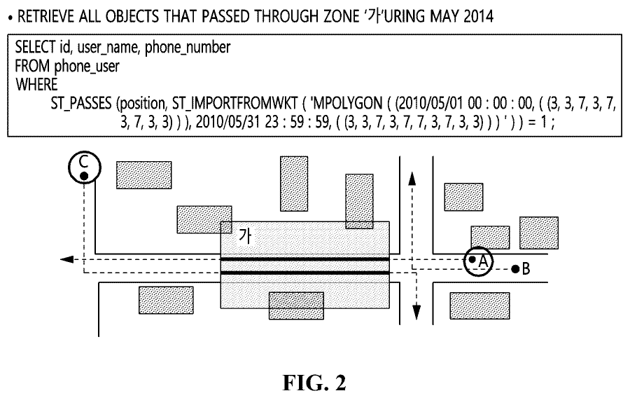

FIG. 2 is a view illustrating a query statement for a specific situation according to an embodiment of the present disclosure.

Referring to FIG. 2, it can be seen that a SQL statement for retrieving all objects that passed through the section ‘Z’ in the space during May 2010 is represented.

Here, it can be seen that the objects that passed through the section ‘Z’ are objects A and C.

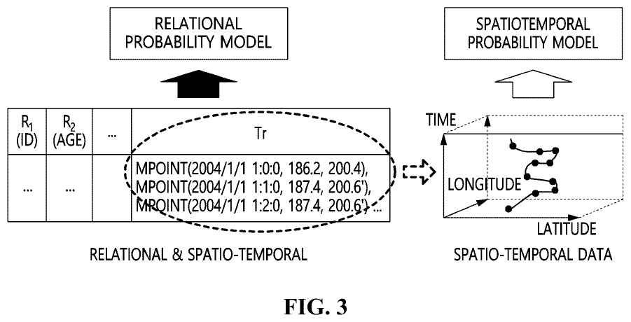

FIG. 3 is a view illustrating a process in which mixed data is input into a relational model and a spatiotemporal model according to an embodiment of the present disclosure.

Referring to FIG. 3, it can be seen that the mixed data is configured with relational data (columns R1, R2, . . . ) and spatiotemporal data (column Tr).

It can be seen that the relational data is represented to include ID, AGE, and the like and the spatiotemporal data represents a record of an object that is located at certain coordinates or is moving in a specific space at a specific time or during a specific period.

Here, it can be seen that the spatiotemporal data in the mixed data (relational & spatiotemporal DAT) is transformed into spatiotemporal data corresponding to a target space in order to use a probabilistic inference model.

Here, the spatiotemporal data may be transformed into 3D spatial data about time, a space, and a trajectory.

For example, the spatiotemporal data may be configured with a Space(S) axis, a Time (T) axis, an Object (Trajectory) (O) axis, and an axis for representing the probability/likelihood value for a combination of the three axes.

In the space axis, dimensions may increase depending on the given data. For example, the S axis may be represented in two dimensions for GPS data including latitude/longitude.

Here, it can be seen that the mixed data is separated into relational data and spatiotemporal data corresponding to the target space so as to be respectively input into the relational model and the spatiotemporal model inside the probabilistic inference model.

It can be seen that Table 1 illustrates a process of transforming a query expressed in SQL statement into a probability expression in order to apply to the probabilistic inference model.

TABLE 1

| | |
|---|---|
| select count(*) from [symbol] p where a = ‘x’ and b = 2 | N * P(a = ‘x’, b = 2) // N = # of Total rows |
| select avg(c) from [symbol] p where a = ‘x’ and b = 2 | N * E(c \| a = ‘x’ and b = 2) |
| select sum(c) from [symbol] p where a = ‘x’ and b = 2 | N [symbol] * P(a = ‘x’, b = 2) * |
| | E(c \| a = ‘x’ and b = 2) // count(*) [symbol] avg(c) |

[symbol]

indicates data missing or illegible when filed

Referring to Table 1, it can be seen that, because the present disclosure is for the purpose of data retrieval/analysis, it is performed on an aggregate query.

The total count of data rows that meet a given condition may be calculated as the product of the number of original data rows (N) and the probability of satisfying the given condition.

The average (avg) of a designated column (c) among the data rows that meet the given condition may be calculated as the product of the number of original data rows (N) and the conditional expectation value for the given condition.

The sum of the designated column (c) among the data rows that meet the given condition may be calculated as the product of the result of the ‘count’ query and the result of the ‘avg’ query.

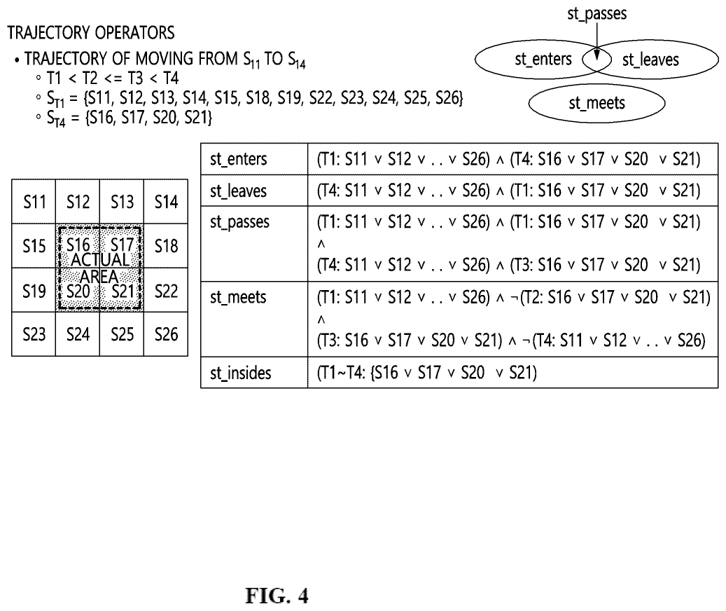

FIG. 4 is a view illustrating the process of processing conditions for spatiotemporal data in a query statement according to an embodiment of the present disclosure.

Referring to FIG. 4, conditions for spatiotemporal data may include not only general arithmetic/logical operators but also operations specialized for specific spatiotemporal data.

The arithmetic/logical operators are reflected in a probability expression without change, and the spatiotemporal-specific operations may be transformed according to separate rules, such as that illustrated in FIG. 4.

For example, it can be seen that trajectory data for a moving object is transformed using five operations (st_enters, st_leaves, st_passes, st_meets, and st_insides) that are generally used.

These five operations may be defined depending on a discretization method according to the LoD applied to a given model.

The ‘st_enters’ operation may check whether the trajectory enters a designated area (ACTUAL AREA including S16, S17, S20, and S21).

It is TRUE if the trajectory in the outer area, including S11 to S15, S18, S19, and S22 to S26, at the time of T1 enters the designated area, including S16, S17, S20, and S21, at the time of T4. The time sequence may be assumed to be T1<T2<=T3<T4.

‘st_insides’ retrieves a trajectory that stays within a designated area during a given time range.

As opposed to ‘st_enters’, ‘st_leaves’ retrieves a trajectory that is present in the designated area at the current time and then moves to the outer area.

‘st_passes’ retrieves a trajectory that enters the designated area from the outer area, stays in the designated area, and then moves to the outer area again.

That is, ‘st_enters’, ‘st_insides’, and ‘st_leaves’ retrieve trajectories that satisfy conditions in chronological order.

‘st_meets’ retrieves a trajectory that touches the designated area.

When other operations are added, rules paired with discretization are defined in the same way.

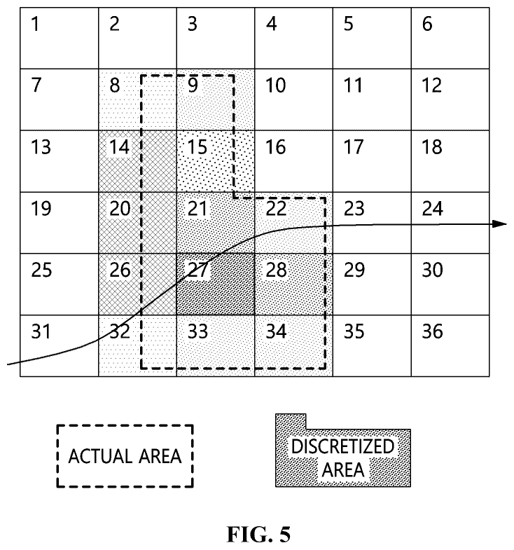

FIG. 5 is a view illustrating the process of discretizing a given target space depending on the Level of Detail (LoD) defined by a user according to an embodiment of the present disclosure.

Referring to FIG. 5, it can be seen that the dotted line represents the actual area before discretization and that cells 1 to 36 are the discretized space.

It can be seen that the curving arrow represents the original trajectory.

It can be seen that the shaded area represents the designated area in the discretized space.

Referring to FIG. 5, it can be seen that the original trajectory passes through the given designated area via cells 32, 26, 27, 21, and 22.

Here, cells 8, 9, 14, 15, 20, 21, 22, 26, 27, 28, 32, 33, and 34 may vary in accuracy depending on the Level of Detail (LoD) defined in advance by a user.

In FIG. 5, it can be seen that the higher the LoD, the darker the shade.

The accuracy depending on the LoD may be provided when the query result is output.

A probabilistic model that learned the original data may compute accuracy. Here, the accuracy depending on the LoD and the accuracy depending on discretization are different, and the two types of accuracy may be provided together.

The LoD suitable for discretization may vary depending on the nature of the problem given to the user.

The present disclosure may assist a user in experimenting with various settings and searching for a suitable setting for a given problem by providing the accuracy for a given LoD.

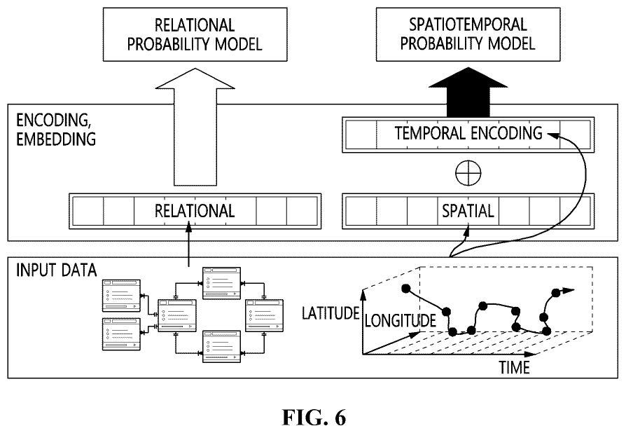

FIG. 6 is a view illustrating a process in which given data is encoded and is then input into two models according to an embodiment of the present disclosure.

Referring to FIG. 6, relational part of source data may be input into a relational probability model according to a given LoD/discretization method.

Spatiotemporal part of the source data may be input into a spatiotemporal probability model according to the given LoD/discretization method.

The above-described discretization process may also be reflected in this procedure.

The spatiotemporal data may be encoded by separately defining encoding for a time axis and encoding for a space axis and then combining the same.

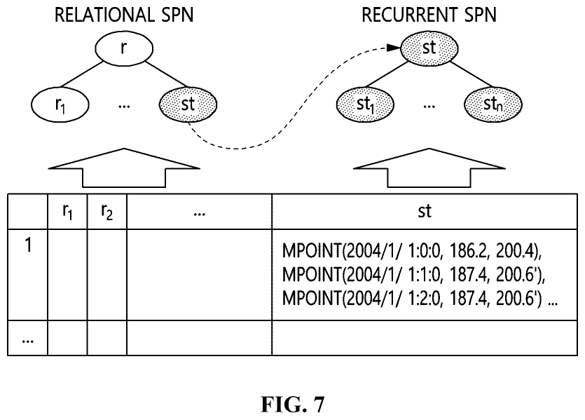

FIG. 7 is a view illustrating a process of simultaneously learning two types of models according to an embodiment of the present disclosure.

Referring to FIG. 7, it can be seen that two types of data (relational data and spatiotemporal (recurrent) data) are represented as different models, and different learning algorithms may be used therefor.

As relational learning algorithms, a LearnSPN-based algorithm (Split/Clustering) may be used.

As spatiotemporal data learning algorithms, an oSLRAU algorithm (Parameter Learn, Structure Learn) may be used.

Sting may be used for learning relational data, and R'SPN may be used for ST operations.

It can be seen that the learning processes of the two models are connected to each other in order to process a query in which two types of data are mixed. That is, the spatiotemporal model may be configured as a partial model of the relational model.

[Pseudocode 1]

```
for row in rows
  r, st = split_intro_r_n_st(row)
  col = update_spatiotemporal(st)
  r.add(col)
  update_relational(r)
```

It can be seen that pseudocode 1 represents the learning algorithm according to an embodiment of the present disclosure.

Referring to pseudocode 1, the learning algorithm of the present disclosure may reflect spatiotemporal-type column data (col=update_spatiotemporal (st)) whereby a relational model calls a spatiotemporal model as if it were invoking a subroutine on the spatiotemporal model, may reflect the result to a random variable node representing the spatiotemporal column in the relational model (r.add (col)), and may update the relational model (update_relational(r)).

From the perspective of the relational model, the spatiotemporal data may be represented as a single random variable (a probability distribution).

Accordingly, when computing the value of a leaf node representing a random variable, the relational model may return the computation result of the spatiotemporal model by calling the spatiotemporal model.

Also, whenever new data is input in the process of learning the relational model, the learning algorithm may check a correlation between variables and reconstruct a probability model (graph).

Also, the learning algorithm stores the latest computed value of a spatiotemporal node and uses the stored cache value if there is no change in the spatiotemporal data when checking the correlation, thereby saving time.

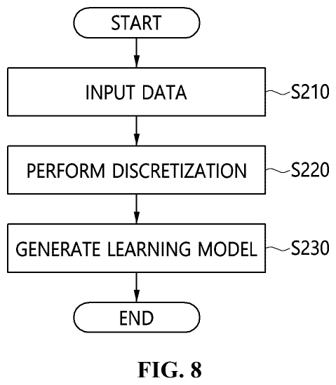

FIG. 8 is a flowchart illustrating a method for learning mixed data for approximate queries according to an embodiment of the present disclosure.

Referring to FIG. 8, in the method for learning mixed data for approximate queries according to an embodiment of the present disclosure, first, mixed data may be input at step S210.

That is, at step S210, mixed data including relational data about information for identifying an object and spatiotemporal data about the trajectory of the object moving in a target space may be input.

Also, in the method for learning mixed data for approximate queries according to an embodiment of the present disclosure, the mixed data may be discretized at step S220.

That is, at step S220, the relational data and the spatiotemporal data may be discretized based on the level of detail that is preset for each designated area of the target space corresponding to the trajectory of the object.

Here, at step S220, transformation into 3D spatial data about time, a space, and a trajectory of the spatiotemporal data may be performed.

Here, at step S220, levels of detail may be set for each designated area based on time during which the object is present in the designated area.

Here, at step S220, the relational data and the spatiotemporal data may be discretized based on a probability expression for checking the trajectory of the object moving in the designated area of the target space.

Also, in the method for learning mixed data for approximate queries according to an embodiment of the present disclosure, a mixed learning model may be generated at step S230.

That is, at step S230, a mixed learning model that learns the relational data and the spatiotemporal data for each level of detail using multiple relational models and spatiotemporal models may be generated.

Here, the spatiotemporal models may be configured with a three-layer structure for learning the 3D spatial data for each layer.

Here, at step S230, the spatiotemporal data corresponding to the relational data is learned by calling a spatiotemporal model, and the result of learning by the spatiotemporal model is reflected to the random variable node representing the spatiotemporal column in the relational model, thereby learning the relational model.

Here, at step S230, in the process of learning the relational model, a correlation between variables is checked whenever new data is input, and the relational model may be learned only when there is a change in the correlation.

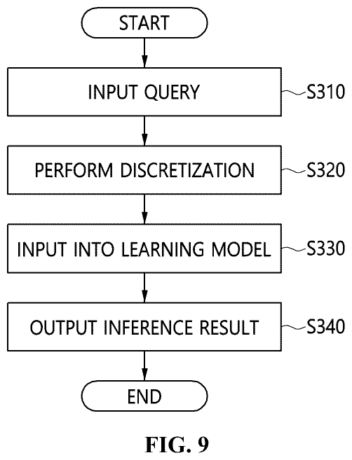

FIG. 9 is a flowchart illustrating an inference method for mixed data for approximate queries according to an embodiment of the present disclosure.

Referring to FIG. 9, in the inference method for mixed data for approximate queries according to an embodiment of the present disclosure, a query may be input at step S310.

That is, at step S310 a query represented as a query statement in Structured Query Language (SQL) or the like may be input.

Here, the query statement may correspond to requesting inference of the trajectory of an object passing through a preset target area according to a specific condition in a target space.

Also, in the inference method for mixed data for approximate queries according to an embodiment of the present disclosure, the query statement may be discretized at step S320.

Here, at step S320, the query statement may be transformed into a probability expression for application to a probabilistic circuits model.

Here, at step S320, the query statement may be discretized depending on the level of detail of the target space.

Also, in the inference method for mixed data for approximate queries according to an embodiment of the present disclosure, the discretized query may be input into a learning model at step S330.

Here, at step S330, the trajectory of the object moving in the target space may be inferred from the query statement using the mixed learning model.

Also, in the inference method for mixed data for approximate queries according to an embodiment of the present disclosure, the inference result may be output at step S340.

Here, a preset probabilistic circuits model may be used for the relational model and the spatiotemporal model.

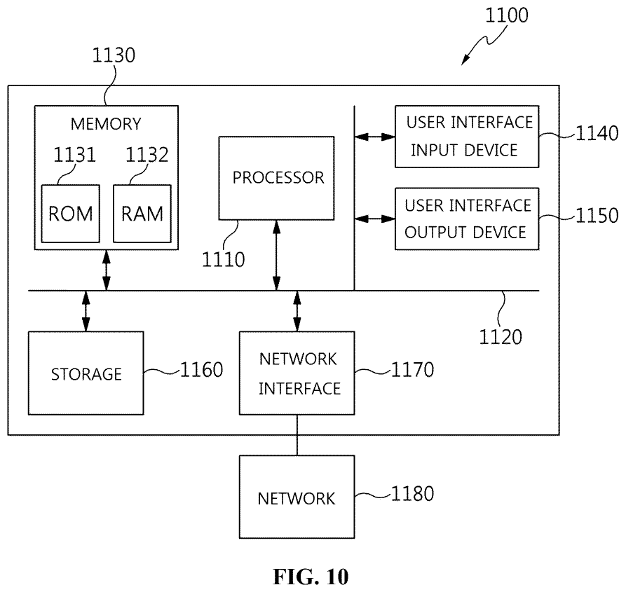

FIG. 10 is a view illustrating a computer system according to an embodiment of the present disclosure.

Referring to FIG. 10, the apparatus 100 for learning mixed data for approximate queries according to an embodiment of the present disclosure may be implemented in a computer system 1100 including a computer-readable recording medium. As illustrated in FIG. 10, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for learning mixed data for approximate queries according to an embodiment of the present disclosure includes one or more processors 1110 and memory 1130 for storing at least one program executed by the one or more processors 1110, and the at least one program receives mixed data, including relational data about information for identifying an object and spatiotemporal data about the trajectory of the object moving in a target space, discretizes the relational data and the spatiotemporal data based on a level of detail that is preset for each designated area of the target space corresponding to the trajectory of the object, and generates a mixed learning model that learns the relational data and the spatiotemporal data for each level of detail using multiple relational models and spatiotemporal models.

Here, the at least one program may perform transformation into 3D spatial data for time, a space, and a trajectory of the spatiotemporal data.

Here, the spatiotemporal model may be configured with a three-layer structure for learning the 3D spatial data for each layer.

Here, the at least one program may set levels of detail for each designated area based on time during which the object is present in the designated area.

Here, the at least one program may discretize the relational data and the spatiotemporal data based on a probability expression for checking the trajectory of the object moving in the designated area of the target space.

Here, the at least one program may learn spatiotemporal data corresponding to the relational data by calling a spatiotemporal model and may learn the relational model by reflecting the result learning by the spatiotemporal model to a random variable node representing a spatiotemporal column in the relational model.

Here, the at least one program may learn the relational model only when there is a change in a correlation between variables by checking the correlation each time new data is input in the process of learning the relational model.

Here, the mixed learning model may infer a trajectory of an object moving in the target space by receiving a query statement.

Here, for the relational model and the spatiotemporal model, a preset probabilistic circuits model may be used.

Here, the query statement may be transformed into a probability expression for application to the probabilistic circuits model.

The present disclosure may improve the efficiency of queries on a vast amount of large-scale mixed data by using approximate query techniques based on machine learning.

Also, the present disclosure may provide the structure and procedure of a machine-learning-based model for efficiently performing exploratory analysis on large-scale mixed data.

Also, the present disclosure may provide a method for training a model and performing inference by transforming original data and queries to improve the efficiency of learning and inference.

Also, the present disclosure may be applied to traffic/navigation data analysis, autonomous vehicles route analysis, car-sharing service analysis, bio/medical data analysis, economic and market trend analysis, and the like.

As described above, the apparatus and method for learning mixed data for approximate queries according to the present disclosure are not limitedly applied to the configurations and operations of the above-described embodiments, but all or some of the embodiments may be selectively combined and configured, so the embodiments may be modified in various ways.

What is claimed is:

1. An apparatus for learning mixed data for approximate queries, comprising:
one or more processors; and
memory for storing at least one program executed by the one or more processors,
wherein the at least one program receives mixed data including relational data about information for identifying an object and spatiotemporal data about a trajectory of the object moving in a target space, discretizes the relational data and the spatiotemporal data based on a level of detail that is preset for each designated area of the target space corresponding to the trajectory of the object, and generates a mixed learning model that learns the relational data and the spatiotemporal data for each level of detail using multiple relational models and spatiotemporal models.

2. The apparatus of claim 1, wherein the at least one program performs transformation into three-dimensional (3D) spatial data about time, a space, and a trajectory of the spatiotemporal data.

3. The apparatus of claim 2, wherein the spatiotemporal model is configured with a three-layer structure for learning the 3D spatial data for each layer.

4. The apparatus of claim 1, wherein the at least one program sets levels of detail for each designated area based on time during which the object is present in the designated area.

5. The apparatus of claim 4, wherein the at least one program discretizes the relational data and the spatiotemporal data based on a probability expression for checking the trajectory of the object moving in the designated area of the target space.

6. The apparatus of claim 4, wherein the at least one program learns spatiotemporal data corresponding to the relational data by calling a spatiotemporal model and learns the relational model by reflecting a result of learning by the spatiotemporal model to a random variable node representing a spatiotemporal column in the relational model.

7. The apparatus of claim 6, wherein the at least one program learns the relational model only when there is a change in a correlation between variables by checking the correlation each time new data is input in a process of learning the relational model.

8. The apparatus of claim 1, wherein the mixed learning model infers a trajectory of an object moving in the target space by receiving a query statement.

9. The apparatus of claim 8, wherein a preset probabilistic circuits model is used for the relational model and the spatiotemporal model.

10. The apparatus of claim 9, wherein the query statement is transformed into a probability expression for application to the probabilistic circuits model.

11. A method for learning mixed data for approximate queries, performed by an apparatus for learning mixed data for approximate queries, comprising:
receiving mixed data including relational data about information for identifying an object and spatiotemporal data about a trajectory of the object moving in a target space;
discretizing the relational data and the spatiotemporal data based on a level of detail that is preset for each designated area of the target space corresponding to the trajectory of the object; and
generating a mixed learning model that learns the relational data and the spatiotemporal data for each level of detail using multiple relational models and spatiotemporal models.

12. The method of claim 11, wherein discretizing the relational data and the spatiotemporal data comprises performing transformation into three-dimensional (3D) spatial data about time, a space, and a trajectory of the spatiotemporal data.

13. The method of claim 12, wherein the spatiotemporal model is configured with a three-layer structure for learning the 3D spatial data for each layer.

14. The method of claim 11, wherein discretizing the relational data and the spatiotemporal data comprises setting levels of detail for each designated area based on time during which the object is present in the designated area.

15. The method of claim 14, wherein discretizing the relational data and the spatiotemporal data comprises discretizing the relational data and the spatiotemporal data based on a probability expression for checking the trajectory of the object moving in the designated area of the target space.

16. The method of claim 14, wherein generating the mixed learning model comprises learning spatiotemporal data corresponding to the relational data by calling a spatiotemporal model and learning the relational model by reflecting a result of learning by the spatiotemporal model to a random variable node representing a spatiotemporal column in the relational model.

17. The method of claim 16, wherein generating the mixed learning model comprises learning the relational model only when there is a change in a correlation between variables by checking the correlation each time new data is input in a process of learning the relational model.

18. The method of claim 11, wherein the mixed learning model infers a trajectory of an object moving in the target space by receiving a query statement.

19. The method of claim 18, wherein a preset probabilistic circuits model is used for the relational model and the spatiotemporal model.

20. The method of claim 19, wherein the query statement is transformed into a probability expression for application to the probabilistic circuits model.
